(19) United States
(12) Patent Application Publication
(10) Pub. No.: US 2007/0274208 A1
(43) Pub. Date: Nov. 29, 2007

(54) System for Transmitting Data and User of the System

(76) Inventors: Werner Harter, Illingen (DE); Eberhard Boehl, Reutlingen (DE)

Correspondence Address: KENYON & KENYON LLP, ONE BROADWAY, NEW YORK, NY, 10004, US

(21) Appl. No.: 11/578,214

(22) PCT Filed: Apr. 13, 2005
(86) PCT No.: PCT/EP05/51639

§ 371 Date: Jul. 30, 2007

(30) Foreign Application Priority Data
Apr. 13, 2004 (DE) 10 2004 018 319.8

(51) Int. Cl. H04L 12/437; G06F 11/00; H04L 12/42

(52) U.S. Cl. 370/223; 370/222; 370/254; 714/717

(57) ABSTRACT

A system having at least three users for transmitting data is provided, the system including two transmission paths among the users, the transmission paths forming a first ring and a second ring having opposite transmission directions. In each user, a first connection by which the first ring is connectible to the second ring, and a second connection by which the second ring is connectible to the first, are provided such that the data transmitted on the two rings are processed in each user.

### FIELD OF THE INVENTION

The present invention relates to a system having at least three users for transmitting data and at least two transmission paths between the users.

### BACKGROUND INFORMATION

Published International patent document WO 02/49271 describes a ring network in which the individual users are connected by two rings having opposite transmission directions. In addition to the use of such redundant, ring-shaped data paths in opposite directions, other voting systems provide for the data in ring-shaped networks to be transmitted several times in the same direction via individual nodes, using additional, redundant connections. In this context, there is, first of all, the disadvantage that in the event of large mechanical effects or also temperature effects, the additional, redundant connections may all be broken at once if they are routed together, or that in order to prevent this, the high expenditure of the separate running of cables becomes necessary.

In distributed systems, e.g., systems that are relevant with regard to safety, an exchange of data between the involved users is necessary, which also results in reliable decisions or analyses in the case of a fault, i.e., the fault must be reliably detected and appropriate measures must be initiated, which prevent a loss of safety or system failure.

Such distributed, safety-related systems are known, for example, from the automotive sector as x-by-wire systems. In this context, the most important objective is to ensure the functional reliability of such systems. In view of the systems known from the related art, an object of the present invention is to further increase the fault-tolerance within the scope of the increased, safety-related requirements.

### SUMMARY

The present invention provides a system having at least three users for transmitting data, including two transmission paths between the users, the transmission paths forming a first ring and a second ring having opposite transmission directions, and a first connection being advantageously provided in each user, the first ring being connectible to the second ring via the first connection, and a second connection being provided, via which the second ring is connectible to the first, and in such a manner that in the case of a failure of the cable connection, the break is detected and the loop between the oncoming ring and the returning ring is closed at the breakpoint. This may be provided for in the cases of both a line break and the failure of individual users. This also ensures the transmission of data from the nodes in front of the break to all of the other nodes. In this network configuration, a connection between all nodes may always be maintained, even when all of the connections between two nodes are broken. Therefore, a common cable for directing transmissions back and forth may also be used for the connection between two nodes, in order to nevertheless ensure increased reliability and fault tolerance. The implementation of a first and a second connection in each user also always ensures the recovery of the clock pulse, in which the data are transmitted, in each user node.

A control unit, in which status information is generated, is advantageously provided in the system or in each user. This status information is exchanged between the rings via the specific connection, which means that evaluation of the fault information contained in it is possible irrespective of the ring in which the status information was generated. For purposes of evaluation, an evaluation unit is advantageously provided, e.g., in the control unit, for evaluating the status information, the evaluation unit being designed in such a manner, that when a fault occurs upon evaluation of the status information, transmission of the data on, in each instance, one ring is prevented, and the data are instead transmitted through the connection to the other ring. In this context, the data are transmitted in specifiable frames, and a coupling unit is advantageously provided, e.g., in the control unit, the coupling unit coupling the status information into a specifiable position in the frame.

As mentioned above, if the data of the two rings is processed in each user, additional redundancy is produced which allows each occurring fault to be detected and appropriate measures such as data rerouting to be initiated, regardless of the ring in which the fault occurred.

The two rings may be driven by the same clock pulse, which means that at least one clock unit, by which the first ring and the second ring are operated with the same clock pulse for transmitting the data, is provided in a user. This has the advantage that when data are rerouted over the first or second connection, a more expensive clock-pulse adjustment process may be avoided to the greatest possible extent.

To increase the amount of redundancy, it is also advantageously provided that at least two clock units be used, which are assigned to at least two different users or contained in them, where, in order to simplify the system of the present invention, only one clock unit advantageously specifies the clock pulse for operating the two rings in each case, and the at least second clock unit specifying the clock pulse in the event of failure of a first clock unit.

In one example embodiment, the users, which contain the at least two clock units or are assigned to them, are positioned as neighbors in the system and in spatial proximity to each other, which means that the clock-pulse level is easily transferred, and the spatial proximity and vicinity allow the transmission paths to be maintained.

However, it is sufficient for one clock unit to be contained in the system, since the configuration of the present invention, in which there are two connections, the data of the two rings is processed in each user, and a common clock pulse is used, allows the clock pulse to be easily recovered from the data transmission in each user, without a separate time base, i.e., clock unit, being necessary in each user.

### BRIEF DESCRIPTION OF THE DRAWINGS

FIG. 1 shows a system of the present invention, having the corresponding communication configuration.

FIG. 2 shows the system in the event of a line break.

FIG. 3 shows the system when a user malfunctions.

FIG. 4 shows the internal configuration of each user.

FIG. 5 shows the configuration of a user having its own time base, i.e., clock unit.

FIG. 6 shows an example of a frame structure according to the present invention.

FIG. 7 shows a master-slave combination in an example system of the present invention.

FIG. 8 shows the failure of the master in the master-slave combination.

FIG. 9 shows the failure of a master or failure of the entire master-slave combination and additional backup master.

FIG. 10 shows the failure of the master or the master-slave combination with a simultaneously occurring, second error, such as selection of a connection or a user with additional backup masters and formation of subsystems.

### DETAILED DESCRIPTION

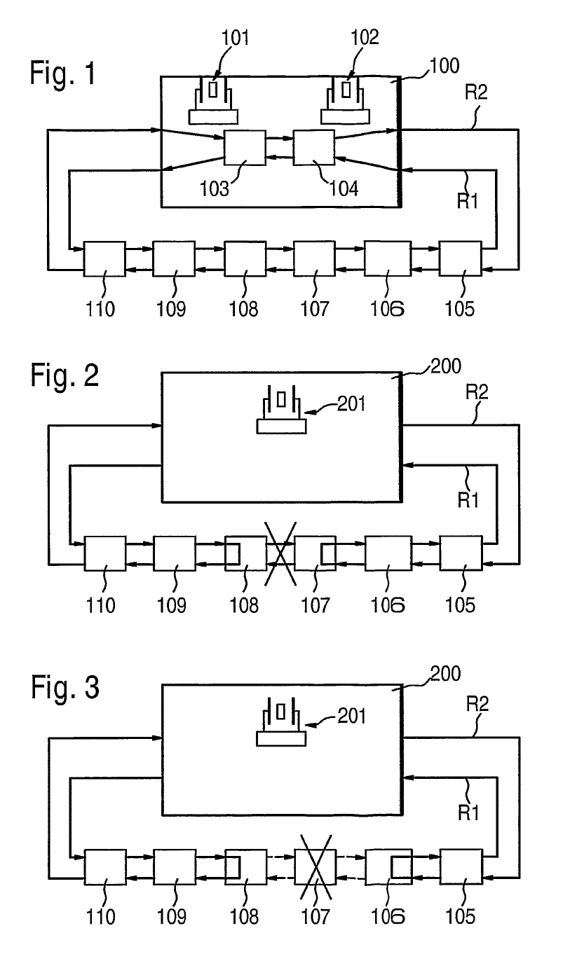

FIG. 1 shows a system configuration having a master-slave combination 100, which includes a master 103 and a slave 104. In addition, six additional users 105 to 110 are represented as slaves, in particular, not having their own clock unit. Users 103 to 110 are connected in two oppositely directed rings R1 and R2, which means that for the purpose of data transmission, two redundant, ring-shaped data paths, i.e., R1 and R2, are used in opposite directions. Master-slave combination 100 may additionally increase the fault tolerance, in that in addition to a master and a slave that can assume the master function, two redundant clock units 101 and 102 are likewise provided. In this context, however, only one clock unit may be provided, which is initially assigned to the master, i.e., not contained in it, and transmits the clock information to slave 104 in the event of a failure, in order to maintain the operation. In this context, it is then necessary for master 103 and slave 104 to be positioned as neighbors and in spatial proximity, in order to be able to easily transmit the clock information.

In FIG. 2, instead of master-slave combination 100, only one master having one clock unit 201 is represented. According to the present invention, the use of master-slave combination 100 or a sole master 200 is optional and interchangeable. If a fault now occurs in the system, e.g., a break of the line, as shown here between user 107 and 108, the data transmission in the system may be maintained by rerouting information in the appropriate users. That is, even when all of the connections between two nodes or users are broken, there is still a reliable exchange of data between all of the nodes. However, this is only accomplished because according to the present invention, the data of the two rings R1 and R2 are always evaluated and processed in each user and, unlike the related art, the data are not simply passed through in one user. FIG. 3 represents the same situation, but only on the assumption that an entire user malfunctions, in this case user 107. However, as already described in FIG. 2, in this case, the transmission of data may also be further maintained for the remaining users, even when, as in this case, a node or a user malfunctions.

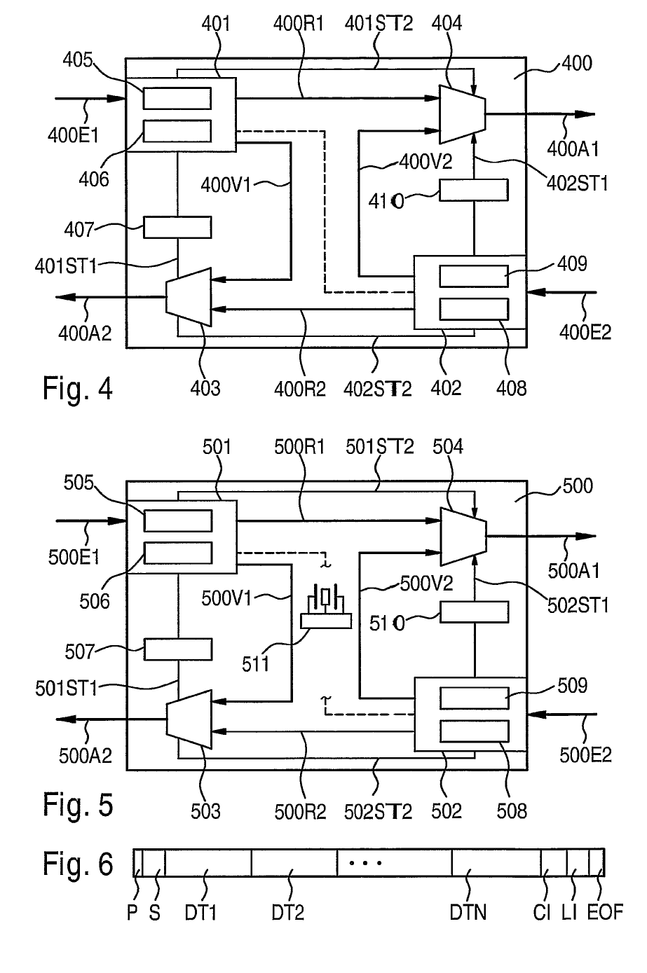

FIG. 4 now shows the configuration of a user, in which cross-connections between the rings are produced.

In FIG. 4, these cross-connections are shown as connection 1, 400V1 and as connection 2, 400V2. The user or node has a first input 400E1 and a first output 400A1, as well as a second input 400E2 and a second output 400A2. In principle, the two transmission paths corresponding to rings R1 and R2 may be implemented via these inputs and outputs. However, the present invention now provides a control unit 401 and 402 corresponding to each transmission path, status information being generated in the control unit. This status information includes, for example, network information regarding the failure of a node or user, or also fault information or the defect status of a capped connection between two users. In accordance with each control unit 401 or 402, each user is capable of generating such a status information item itself. This status information is then exchangeable between the rings via respective connection 400V1 or 400V2. This is accomplished by coupling the status information, in particular, into the data frame with the aid of a coupling unit 406, the data frame being described in detail in FIG. 6. Unit 407 is used for determining the exact position of the status information in the frame, which may be accomplished, for example, by a counter that counts bits or bytes.

The same applies to the other direction with coupling unit 409 and detection unit 410. Also provided is an evaluation unit 405, or 408 for the other direction for evaluating the status information coming through the inputs into the frame. In this context, these units 405, 406, 407 may be provided in the control unit or externally. This is also true for the other direction, for elements 408, 409, and 410. Evaluation unit 405, or 408 in the reverse direction, is used now for evaluating the status information and is designed so that when a fault detection occurs during the evaluation of the status information, e.g., the failure of a connection or a user or another error in the network, the transmission of data on the corresponding ring, i.e., on the regular connection, in this case 400R1, may be prevented, and instead, coupling may take place via connection 400V1. This connection 400V1 may now be directly activated via control input 401ST1 of switching element 403, which means that first of all, special status information may be supplied to the appropriate position in the transmission frame in the opposite direction just as every other data item, or, in the case of a gross error, the information may be completely rerouted from regular path 400R1 via connection 400V1. In this context, transmission via 400R1 is prevented by control connection 401ST2 to switching element 404, if the fault has occurred in ring R1. This analogously takes place for the other direction via control unit 402 and evaluation unit 408. In this case, connection 400V2 is at least partially activated via control input 402ST1, i.e., the transmission of status information or other data up to the rerouting of all of the data in accordance with detection element 410, and in the same manner, the regular transmission in ring R2 via 400R2 may be prevented by control input 402ST2 of switching element 403. According to the present invention, a connection may be additionally provided between the control units, shown here by a dotted line, in order to balance such measures between the control units as a function of corresponding faults or the importance of the faults, which may be entered into a priority table for this purpose.

FIG. 5 now shows the same functionality for a user having clock unit 511; in this case, control units 501 and 502, evaluation units 505 and 508, detection units 507 and 510, coupling units 506 and 509, switching elements 503 and 504, corresponding control inputs 501ST2 and 501ST1, as well as 502ST2 and 502ST1 for activating connections 500V1 and 500V2 are also provided, in order to allow data coupling into the different rings or the switching of input 500E1 to output 500A2, or of input 500E2 to output 500A1. This user principally differs from FIG. 4 in that it contains a clock unit 511 and may therefore act as a master or backup master in the system. Otherwise, the functionality of the mentioned parts corresponds to the functionality already described in FIG. 4. In this case, the two control units 501, 502 may also be connected for purposes of synchronization. FIG. 6 provides an example of a frame for transmitting data, so that all of the data are transmitted in synchronous frames, each node involved with voting being assigned a specific data area. The provided frame begins here with a preamble P, which marks the start of the frame. After that, the status information, which may contain from one bit up to one byte or several bytes, is represented by S. Reference characters DT1, DT2 through DTN correspond to the data areas of respective users T1, T2 through TN, i.e., in the preceding figures, 103 through 110 or 200, which are involved with the voting. Additional control information is provided by CI, loop information is provided by LI, and EOF indicates the end of the frame. Thus, according to FIGS. 4, 5, and 6, status information obtained by evaluating a ring in accordance with specific evaluation unit 406, 408, 506, or 508 and transmitting the information to the oppositely directed ring in a special status area S, with corresponding evaluation of this status information in, in each instance, the next node or user allows faults to be detected and, therefore, correction data to be coupled in, or allows a complete switchover to be made to the specific connection in the case of a defective status of a user or a line between the users. This means that, e.g., based on FIG. 4 or FIG. 5, the information, in particular the status information, goes from the one direction through input E2, i.e., 400E2 or 500E2, into the control unit and is evaluated, and on the other side, it goes in the opposite direction through input El, i.e., 400E1 or 500E1, into control unit 501 or 401, as well, and is evaluated there, as described in FIG. 4. Therefore, faults, in particular breaks in lines between two nodes or users, may be automatically detected, in fact, exactly as the complete separation of the two rings at this position or the complete failure of a user. In this context, one user acts as a master and selects the clock pulse of its clock unit for the entire network, i.e., the entire system. In so doing, the clock unit may be made to be redundant, as already described, and in the case of a master-user fault, each node having access to such a clock-pulse generating element, i.e., to such a clock unit, can assume the function. Depending on the magnitude of the fault, as already described in FIGS. 2 and 3, either the data stream may be completely switched over, i.e., rerouted from one ring to the other ring, or in less serious cases, a bypass may be produced. This means that in addition to the bypassing, a correction may also be carried out by coupling in information from the other control unit of the opposite circuit, as already described.

According to FIG. 6, the information or the data of the system are transmitted in frames of a predefined length. In this context, e.g., 32, 64, or 128 bytes may be used, or also other arbitrary frame lengths. Each frame begins with a preamble P, and the data are coded in such a manner that the clock pulse may be recovered by a PLL, for example. In this context, the data transmission may be carried out on a physical, electric layer, such as LVDS (low voltage differential signaling) or UTP (unshielded twisted pairs). For all active nodes or users, i.e., the ones taking part in voting, frame positions DT1, DT2 through DTN are provided in accordance with the respective user. In this context, the length is a function of the specifiable number of users or nodes, which take part in the voting. Due to the synchronous functioning of all of the nodes or users, i.e., use of the same clock frequency of the same clock pulse, it is possible to bypass all information or all of the data, which have not been generated by the affected users. An optimum implementation of such a bypass requires two or three flipflops or comparable memory devices and delay elements, in order to be able to synchronize the new data, which may be integrated by each user, along with the data set to be bypassed, onto this specific configuration in the frame. Therefore, irrespective of the data set to be inserted or the affected-user data to be inserted, the entire data structure or all of the data is/are only delayed for two or three clock pulses in each node and therefore appear to be nearly simultaneous for all of the receiving users. If a fixed frame position is used for the data of each user, then no address overhead is needed. Therefore, the total transmission rate or the entire frame may be almost completely utilized for useable information. This, combined with the simultaneous transmission of all nodes, produces a very short data-exchange period, even for complex procedures.

At this point, the voting procedure or the evaluation procedure should be briefly described again. In order to carry out voting, each user must be able to perform arithmetic, logical, and comparison operations. To this end, e.g., a simple or small processor in each voting unit may be used for executing these tasks. This small processor may then constitute the control unit or be included in it, in order to control the flow of data, evaluate the status information, and monitor the correct operation of the users, as described in FIG. 4 and FIG. 5. The different users of the system carry out the evaluation procedure, i.e., the voting, independently of each other. Each user receives input variables, e.g., of sensors, and uses these for a calculation process. The input variables of the users may differ by a tolerable order of magnitude as a function of the various sensors that are necessary for safety systems. However, in order to nevertheless start from the same input variables, all of the input variables may be exchanged, evaluated, and appropriately replaced at the beginning of the evaluation procedure of the voting as a function of the specific calculation. The calculation is then performed as a second step, and the results are exchanged. After that, the voting may then be carried out in each user, and the evaluation results may likewise be exchanged. The evaluation of these voting results then allows the actuators to be controlled, in order to produce the desired system reaction. Users that supply unacceptable results at the end of the voting procedure may be excluded from the evaluation. Therefore, the users, in particular the ones that remain after exclusion, may operate in an adjusted manner without a considerable effect on the global system behavior. In this context, information for separating the different phases of this evaluation process from each other, such as the type of data transmitted and the validity of these data, may also be stored in the status information. Also, the system status and the number of active users, as well as the status of these users with regard to the voting. Therefore, each user can evaluate the status of any other user, and in the event of differences, faults may easily be discovered. This is possible since each user may obtain all of the information of all of the other users, even when it is excluded from the voting process. Therefore, when an already excluded user conforms with an evaluation result, it may also be reintroduced into the voting process, e.g., by a master decision. In this manner, in particular, transient errors in users, which only result in the temporary exclusion of the user, are detected and controlled.

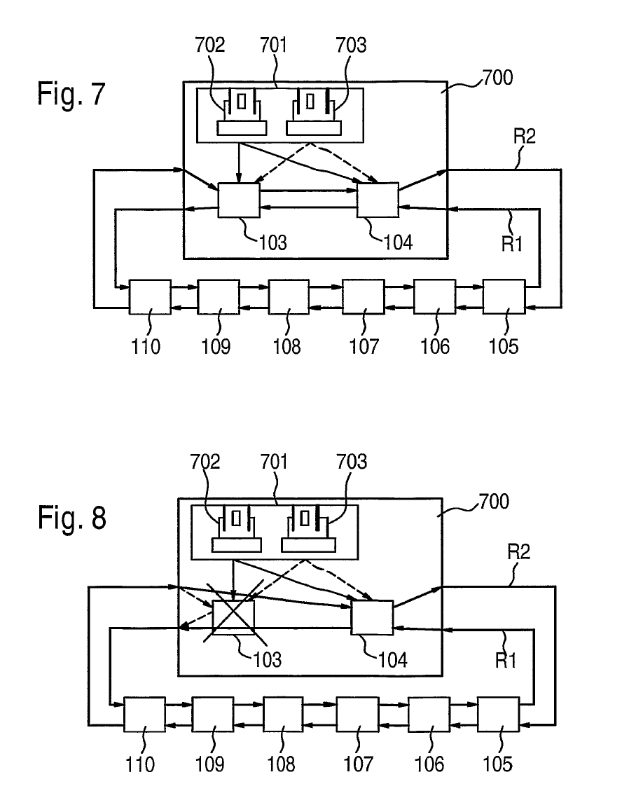

The incoming data information must be checked in each user, e.g., for code errors, preambles, number of bytes, number of the frame, the EOF byte, etc. In the case of a lack of system activity or a fault in the frame structure or other occurring error, in particular, of the preceding node or user, it can be excluded as described above. For this reason, loop information LI is inserted after control information CI, in order to transmit information about one ring, i.e., about the one transmission direction, on the other ring or in the other transmission direction, in order to ascertain the accessibility of the user from the two transmission directions or the two rings R1, R2. Therefore, since they receive the same information as the master user, all of the non-master users may monitor the master user and independently act in the case of inexplicable master decisions. Therefore, a master may be actively excluded from the system in the same way as a faulty non-master; either using a bypass or by rerouting, without taking serious safety risks in the system, which means that as much functionality as possible is produced in the event of individual errors or a plurality of errors. This is described again in detail on the basis of FIGS. 7 through 10.

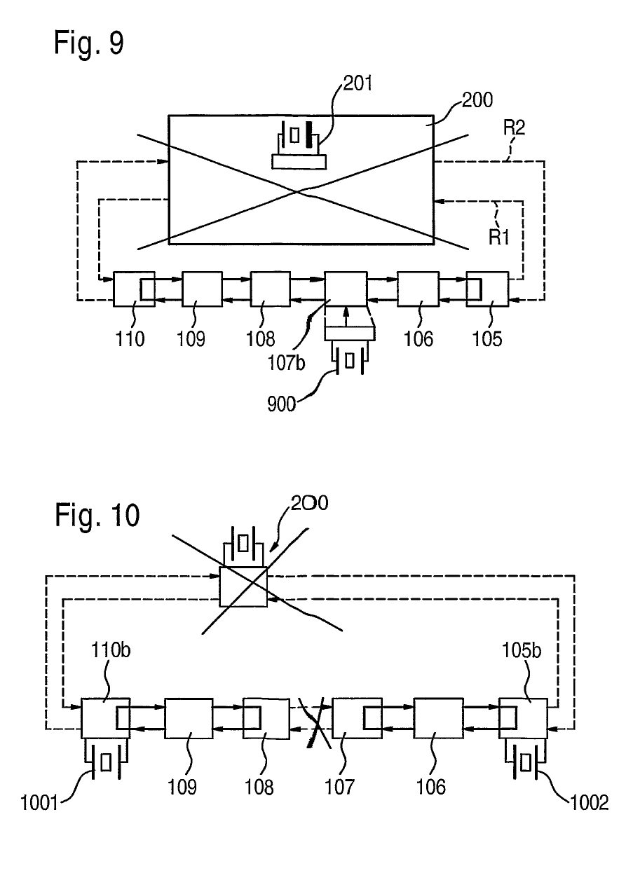

FIG. 7 again shows a system configuration having a master-slave set-up 700, a master 103, and a non-master user 104. Represented in block 701 are redundant clock units 702 and 703, which may be assigned to either master 103 or non-master 104 and may thus specify the clock pulse for the system, i.e., rings R1 and R2, along with users 105 to 110 and 103 and 104. The implementation of this master-slave combination 700, having a plurality of clock-pulse generators or clock units 702 and 703 and spatial proximity between the master and the non-master, allows the master, and even the previous data paths, to be easily replaced in the event of failure, as described in FIG. 8. If master 103 malfunctions, then first of all, a connection of user 104 to user 110 may be produced with respect to ring 1, and secondly, a connection may be produced between user 110 and user 104 with respect to ring 2, by bypassing defective master 103. In the event of a complete breakdown of the master-slave combination or a simple master 200 having clock units, as shown in FIG. 9, the operation of remaining users 105 to 110 may nevertheless be maintained, as shown, if a backup master, in this case 107b, has access to an additional clock unit 900. A plurality of such replacement masters or backup masters may also be provided in the system, which means that safety scaling or error scaling is also possible here. Thus, e.g., when two backup masters 105b and lob having access to clock units 1001 and 1002 are used, as described in FIG. 10, and master 200 and the connection between users 107 and 108 simultaneously break down, subsystems may also be formed, which, for their part, may continue to maintain a certain basic function. If three or more users continue to be included in such a subsystem, the voting, i.e., the evaluation, may also continue to be carried out, and indeed, for the functions that are controlled by these users. In the case of the additional two users remaining, at least a pay-safe analysis may take place while the functionalities are simply compared for equality. Therefore, scaling within the scope of fault tolerance may take place as a function of the clock units used in the system, i.e., the number and the configuration, in that potential subnetworks may be predefined.

Therefore, the present invention provides a system for applications that are critical with regard to safety and have stringent real-time requirements. In particular, in the case of a variable master, where the master fails, high response times, especially of the PLL to the new system frequency, i.e., to the new clock pulse, have had to be reckoned with up to this point. This disadvantage may be circumvented by the present invention due to the option of avoiding this variable master, as well as due to the use of the same clock pulse for the two rings or transmission paths. Complete safety may be simultaneously attained, since in the present configuration having the corresponding function, a complete exchange of data continues to be ensured when all connections between two users have been broken, or also when a user, in particular the master, completely fails. Therefore, the present invention may be advantageously used for all applications that are critical with regard to safety, in particular in X-by-wire systems, and especially everywhere where an evaluation, i.e., voting, is carried out.

1-14. (canceled)

15. A system for facilitating data transmissions among at least three user units, comprising:
at least two transmission paths provided among the at least three user units, the at least two transmission paths forming a first transmission ring and a second transmission ring that have opposite transmission directions;
a first connection element provided in each user unit for connecting the first transmission ring to the second transmission ring; and
a second connection element provided in each user unit for connecting the second transmission ring to the first transmission ring;
wherein data transmitted on the first and second transmission rings are processed in each user unit.

16. The system as recited in claim 15, further comprising:
at least one control unit for generating status information.

17. The system as recited in claim 16, wherein the status information is exchanged between the first and second transmission rings via at least one of the first and second connection elements.

18. The system as recited in claim 16, further comprising:
an evaluation unit for evaluating the status information, wherein the evaluation unit is configured such that when a fault is detected upon evaluation of the status information, transmission of data on one of the first and second transmission rings is prevented, and transmission of data is rerouted through the other transmission ring.

19. The system as recited in claim 16, further comprising:
a coupling unit, wherein data are transmitted in predefined frames, and wherein the coupling unit couples the status information into a specified position in a frame.

20. The system as recited in claim 15, further comprising:
at least one clock unit provided in a user unit, wherein the first transmission ring and the second transmission ring are driven by the at least one clock unit with the same clock pulse for transmitting data.

21. The system as recited in claim 20, wherein at least two clock units are provided, and wherein the at least two clock units are contained in at least two different user units.

22. The system as recited in claim 21, wherein only one clock unit selects a clock pulse for operating the first and second transmission rings, and wherein if a first clock unit malfunctions, a second clock unit selects the clock pulse.

23. The system as recited in claim 21, wherein the two different user units containing the at least two clock units are positioned adjacent to each other.

24. A user unit for a system for transmitting data, comprising:
a first input and a first output for transmitting data in a first transmission direction;
a second input and a second output for transmitting the data in a second transmission direction, wherein the first and second transmission directions are opposite to each other;
a first connection element for facilitating selective connection of the first input to the second output; and
a second connection element for facilitating selective connection of the second input to the first output;
wherein data transmitted in the first and second transmission directions are processed in the user.

25. The user unit as recited in claim 24, further comprising:
at least one control unit for generating status information.

26. The user unit as recited in claim 25, wherein the status information is exchanged between the first and second transmission directions via at least one of the first and second connection elements.

27. The user unit as recited in claim 25, further comprising:
an evaluation unit for evaluating the status information, wherein the evaluation unit is configured such that when a fault is detected upon evaluation of the status information, transmission of data on one of the first and second outputs is prevented, and transmission of data is rerouted through the other output.

28. The user as recited in claim 25, further comprising:
a coupling unit, wherein data are transmitted in predefined frames, and wherein the coupling unit couples the status information into a specified position in a frame.
